(19) United States
(12) Patent Application Publication
(10) Pub. No.: US 2007/0093098 A1
(43) Pub. Date: Apr. 26, 2007

(54) Elastic exercising device

(76) Inventor: Yu-Shu Chou, Taipei (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/585,373

(22) Filed: Oct. 24, 2006

(30) Foreign Application Priority Data
Oct. 25, 2005 (TW) 094218403

(51) Int. Cl. H01R 13/62

(52) U.S. Cl. 439/157

(57) ABSTRACT

An elastic exercising device has two connectors and at least one elastic wire connected between the connectors. Each connector has a fastener structure. The elastic wire has two distal ends to which two stopper structures are respectively formed to secure with the fastener structures of the connectors. The stopper structures as well as the fastener structures allow a user to easily add additional elastic wires between the connectors or remove them from the connectors. Therefore, the number of the elastic wires of the exercising device is adjustable to meet different user's conditions.

### BACKGROUND OF THE INVENTION

1. Field of the Invention

The present invention relates to an elastic exercising apparatus, and particularly relates to an exercising device that is easy to adjust the load, i.e. the number of the elastic wires of the exercising device, to meet different users' conditions.

2. Description of the Prior Arts

As the indoor exercising activities increase, many different types of exercising devices such as chest expanders are developed to emphasize conditioning of one or more specific muscle groups.

With reference to FIG. 8, a conventional chest expander has two handles (40) and multiple springs (41) connected between the two handles (40). When a user grabs and pulls the handles (40) in opposite directions, the user can feel the counterforce generated by the springs (41). By reacting against the spring force, the user is able to obtain desired exercise effects.

However, the conventional chest expander has some drawbacks. First, since the springs (41) of the chest expander are made of metal material, users may be injured by the springs (41) due to incorrect operations. Second, the number of the springs (41) cannot be adjusted to meet different users' conditions because the springs (41) are connected to the handles (40) in a fixed way.

To overcome the shortcomings, the present invention provides an elastic exercising device to mitigate or obviate the aforementioned problems.

### SUMMARY OF THE INVENTION

An objective of the present invention is to provide an elastic exercising device that allows a user to easily increase or decrease the elastic force generated by the exercising device to meet different users' conditions.

The elastic exercising device has two connectors and at least one elastic wire connected between the connectors. Each connector has a fastener structure. The elastic wire has two distal ends to which two stopper structures are respectively formed to secure with the fastener structures of the connectors. The stopper structures as well as the fastener structures allow a user to easily add additional elastic wires between the connectors or remove them from the connectors. Therefore, the number of the elastic wires of the exercising device is adjustable to meet different user's conditions.

Moreover, the soft material of the elastic wires also prevents the users from being injured. For convenience of using and carrying the exercising device, the weight of the exercising device can be effectively decreased web most of the components are formed by plastic-based material.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of an elastic exercising device in accordance with the present invention;

FIG. 2 is an exploded perspective view in part of the elastic exercising device of FIG. 1;

FIG. 3 is a cross-section view of a housing assembled with a connector and an elastic wire having a first embodiment of a stopper structure;

FIG. 4 is a cross-section view of a housing assembled with a connector and an elastic wire having a second embodiment of a stopper structure;

FIG. 5 is a plan view of a second embodiment of a connector in accordance with the present invention;

FIG. 6 is a plan view of a third embodiment of a connector in accordance with the present invention;

FIG. 7 is a plan view of a fourth embodiment of a connector in accordance with the present invention; and

FIG. 8 is a plan view of a conventional exercising device.

### DETAILED DESCRIPTION OF THE PREFERRED EMBODIMENTS

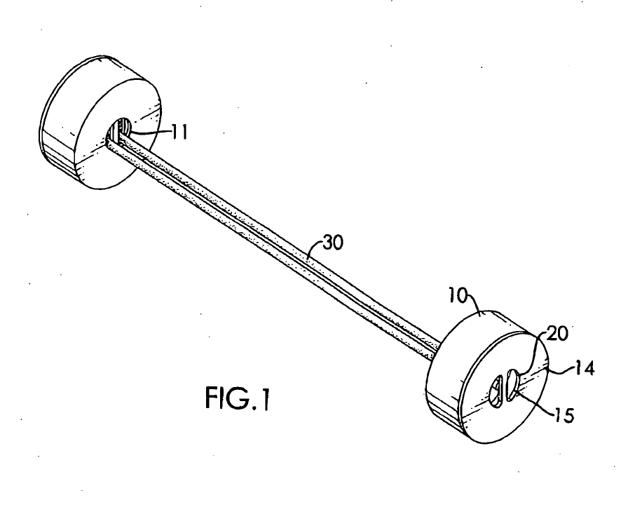

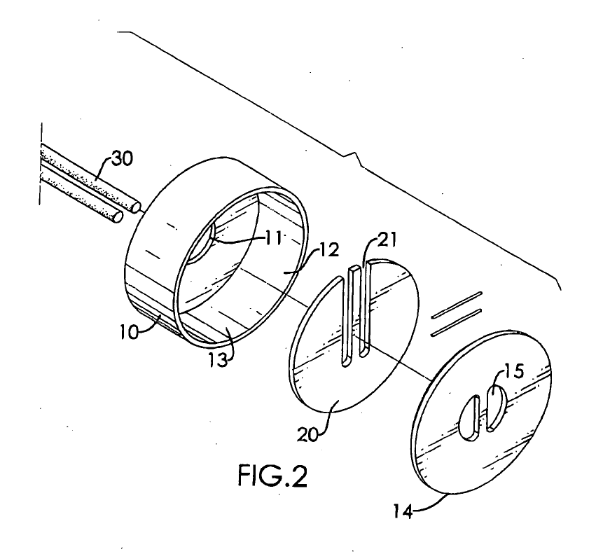

With reference to FIGS. 1 and 2, an elastic exercising device in accordance with the present invention generally comprises two housings (10), two connectors (20) in the housings (10) and at least one elastic wire (30).

Each of the housings (10) has a chamber (12) with a bottom, a center through hole (11) defined in the bottom of the chamber (12), and further has an opening (13) communicating with the chamber (12) and a detachable lid (14) mounted on the opening (13). The lid (14) has two operation holes (15) that are symmetrically defined on the lid (14). With the operation holes (15), a user can easily detach the lid (14) from the housing (10).

The two connectors (20) are respectively mounted in the housings (10). In this embodiment, the connector (20) is a circular board corresponding to the shape of the chamber (12). Each connector (20) has a fastener structure (21). The fastener structure (21) of the first embodiment is two longitudinal slots defined on the connector (20) in parallel. Each slot has a width and two ends. A first end is an opening end defined at the periphery of the connector (20), and a second end is a closed end near a center of the connector (20). The two closed ends of the connector (20) correspond to the through hole (11) of the housing (10).

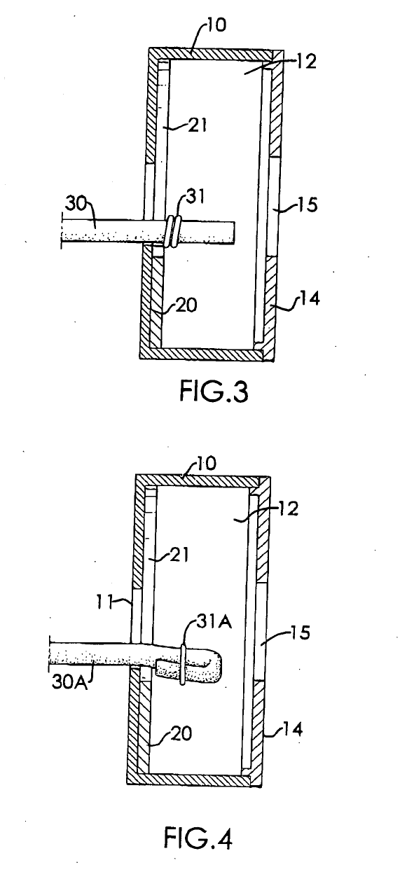

With further reference to FIGS. 2 and 3, each elastic wire (30) can be made of soft and elastic material such as nylon. Each wire (30) has two ends. Each end of the elastic wire (30) has a stopper structure (31). The stopper structure (31) has a size larger than the width of each slot. Therefore, when the two ends of the elastic wire (30) respectively pass through the holes (11) and the fastener structures (21), the stopper structures (31) allow the two ends of the elastic wire (30) to be firmly secured in the housings (10). The stopper structure (31) shown in FIG. 3 is a loop formed by a twisted metal wire that abuts and blocks the slot of the connector (20) to prevent the elastic wire (30) from detaching from the connector (20).

When a user pulls the two housing (10) or two ends of the elastic wire (30) in opposite directions, the elastic wire (30) generates a counterforce against the pulling force to provide an exercise effect. Furthermore, as the user pulls the elastic wire (30), the through hole (I 1) of the housing (10) can limit the stopper structure (31) to the closed end of the slot on the connector (20).

To increase the load of the exercising device, i.e. the counterforce or elastic force of the elastic wire (30), the user can add more elastic wires (30) between the housings (10). The fastener structure (21), i.e. the longitudinal slots, allows additional elastic wires (30) to be secured on the connector (20). In another aspect, the user can remove elastic wires (30) from the housings (10) to mitigate the load.

With reference to FIG. 4, the stopper structure (31 A) is formed by bending the distal end of the elastic wire (30) and winding a loop on the bent distal end. The loop can be made of metal material.

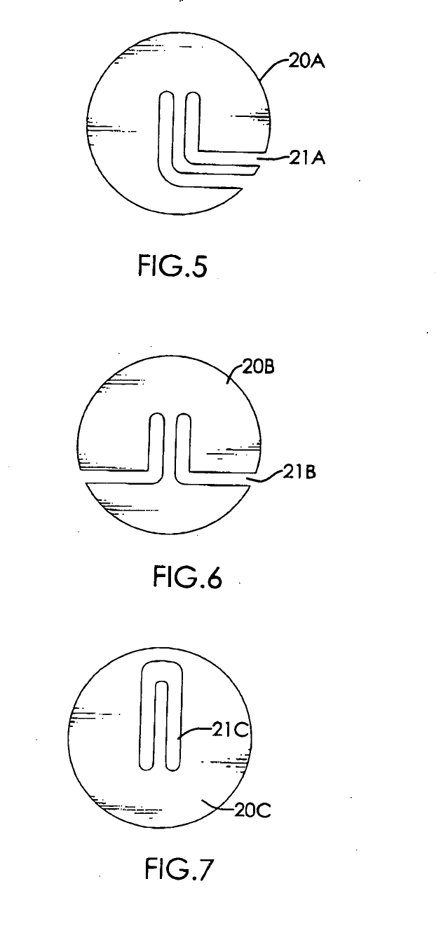

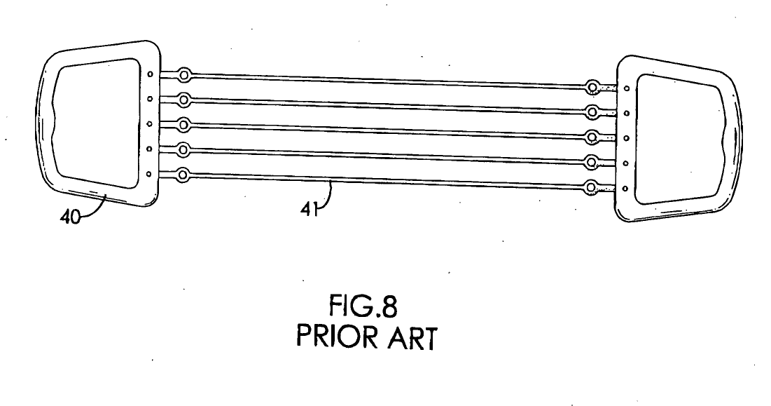

With reference to FIG. 5, another embodiment of the fastener structure (21A) on the connector (20A) comprises two L-shaped slots. Each of the L-shaped slots has a horizontal aperture with an opening end defined on the periphery of the connector (20A) and a vertical aperture with a closed end near the center of the connector (20A). The two horizontal apertures with the opening ends of the L-shaped slots are parallel to each other. The two vertical apertures with the closed ends are also in parallel to each other. Further, each L-shaped slot has a width that is equal to or smaller than the diameter of the elastic wire (30).

With reference to FIG. 6, another embodiment of the fastener structure (21B) on the connector (20B) comprises two symmetrical L-shaped slots. This embodiment differs from FIG. 5 in that the horizontal apertures with the opening end extend in opposite directions. Further, each L-shaped slot has a width that is equal to or smaller than the diameter of the elastic wire (30).

With reference to FIG. 7, yet another embodiment of the fastener structure (21C) on the connector (20C) is a U-shaped slot with two distal ends near the center of the connector (20C). The U-shaped slot is composed of a middle aperture and two parallel longitudinal apertures communicating with the middle apertures. The middle aperture of the U-shaped slot is slightly larger than the parallel longitudinal apertures of the U-shaped slot in width. Therefore, the middle portion allows the elastic wire (30) with the stopper structure (31) to pass through the connector (20C). The elastic wire (30) with the stopper structure (31) is movable along the parallel apertures of the U-shaped slot.

In short, with the stopper structures (31, 31A) of the elastic wires (30, 30A) as well as the fastener structures (21, 21A, 21B, 21C) of the connectors (20, 20A, 20B, 20C), the number of the elastic wires (30,30A) can be easily adjusted to meet different user's physical conditions. Moreover, the soft material of the elastic wires (30,30A) also prevents the users from being injured.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An elastic exercising device comprising:
two connectors, each of the connectors having a fastener structure; and
at least one elastic wire that has two distal ends, each distal end extending through one of the connector and having a stopper structure to be secured and retained by the fastener structure.

2. The elastic exercising device as claimed in claim 1, wherein the stopper structure is a metal loop-twisted on the distal end of the elastic wire.

3. The elastic exercising device as claimed in claim 1, wherein the stopper structure is formed by bending the distal end of the elastic wire and winding a metal loop on the bent distal end.

4. The elastic exercising device as claimed in claim 2 further comprising:
two housings each having
a chamber holding one of the connectors in the housing and having a bottom;
a center through hole defined through the bottom of the chamber and allowing the elastic wire to pass through the center through hole;
an opening communicating with the chamber; and
a detachable lid mounted on the opening and having operation holes.

5. The elastic exercising device as claimed in claim 3 further comprising;
two housings each having
a chamber holding one of the connectors in the housing and having a bottom;
a center through hole defined-through the bottom of the chamber and allowing the elastic wire to pass through the center through hole;
an opening communicating with the chamber; and
a detachable lid mounted on the opening and having operation holes.

6. The elastic exercising device as claimed in claim 4, wherein the fastener structure on each connector is two longitudinal slots parallel to each other, and each slot has
a first end as an opening end defined on periphery of the connector; and
a second end as a closed end near a center of the connector.

7. The elastic exercising device as claimed in claim 5, wherein the fastener structure on each connector is two longitudinal slots parallel to each other, and each slot has
a first end as an opening end defined on periphery of the connector; and
a second end as a closed end near a center of the connector.

8. The elastic exercising device as claimed in claim 4, wherein the fastener structure on each connector is two L-shaped slots, and each L-shaped slot has
a horizontal aperture having an opening end defined on periphery of the connector; and
a vertical aperture communicating with the horizontal aperture and having a closed end near a center of the connector;
wherein the two horizontal apertures with the opening ends are parallel to each other, and the two vertical apertures with the closed ends are parallel to each other.

9. The elastic exercising device as claimed in claim 5, wherein the fastener structure on each connector is two L-shaped slots, and each L-shaped slot has
a horizontal aperture having an opening end defined on periphery of the connector; and
a vertical aperture communicating with the horizontal aperture and having a closed end near a center of the connector;
wherein the two horizontal apertures with the opening ends are parallel to each other, and the two vertical apertures with the closed ends are parallel to each other.

10. The elastic exercising device as claimed in claim 4, wherein the fastener structure on each connector is two symmetrical L-shaped slots and each L-shaped slot has
a horizontal aperture having an opening end defined on periphery of the connector; and
a vertical aperture communicating with the horizontal aperture and having a closed end near a center of the connector;
wherein the two vertical apertures with the closed ends are parallel to each other the two horizontal apertures with the opening ends extend in opposite directions.

11. The elastic exercising device as claimed in claim 5, wherein the fastener structure on each connector is two symmetrical L-shaped slots and each L-shaped slot has
a horizontal aperture having an opening end defined on periphery of the connector; and
a vertical aperture communicating with the horizontal aperture and having a closed end near a center of the connector;
wherein the two vertical apertures with the closed ends are parallel to each other the two horizontal apertures with the opening ends extend in opposite directions.

12. The elastic exercising device as claimed in claim 4, wherein the fastener structure on each connector is a U-shaped slot composed of a middle aperture communicating with two parallel longitudinal apertures, and each longitudinal apertures has a closed end corresponding to the center through hole of the housing; wherein the middle aperture is slightly larger than the two parallel longitudinal apertures of the U-shaped slot in width.

13. The elastic exercising device as claimed in claim 5, wherein the fastener structure on each connector is a U-shaped slot composed of a middle aperture communicating with two parallel longitudinal apertures, and each longitudinal apertures has a closed end corresponding to the center through hole of the housing; wherein the middle aperture is slightly larger than the two parallel longitudinal apertures of the U-shaped slot in width.
